(19) United States
(12) Patent Application Publication
(10) Pub. No.: US 2014/0171563 A1
(43) Pub. Date: Jun. 19, 2014

(54) Composition including a semi-aromatic polyamide and uses thereof, in particular for a reflector having a light-emitting diode

(71) Applicants: Thierry Briffaud, Caorches Saint Nicolas (FR); Philippe Blondel, Bernay (FR); Quentin Pineau, Evreux (FR); Shinya Matsuno, Kyoto (JP)

(72) Inventors: Thierry Briffaud, Caorches Saint Nicolas (FR); Philippe Blondel, Bernay (FR); Quentin Pineau, Evreux (FR); Shinya Matsuno, Kyoto (JP)

(73) Assignee: ARKEMA FRANCE, Colombes (FR)

(21) Appl. No.: 14/127,532

(22) PCT Filed: Jun. 21, 2012
(86) PCT No.: PCT/FR2012/051418

§ 371 Date: Feb. 28, 2014

(30) Foreign Application Priority Data
Jun. 24, 2011 (FR) 11.55597

(51) Int. Cl. C08K 13/04

(52) U.S. Cl. CPC C08K 13/04
USPC 524/147

(57) ABSTRACT

The invention relates to a composition including 30 to 97 wt % of at least one semi-aromatic polyamide, 2 to 50 wt % of white pigments, 0 to 50 wt % of strengthening agents, 0.1, to 10 wt % of at least one metal hydroxide and/or of at least one metal oxide other than a metal oxide, and up to 3 wt % of an organic phosphite. The invention also relates to the use of said composition for forming all or part of an electronic component, as well as to a reflector having a light-emitting diode (LED) and entirely or partially consisting of a material obtained form said composition.

### FIELD OF THE INVENTION

The present invention relates to a composition comprising a semiaromatic polyamide and also to the uses thereof, especially in the manufacture of electronic components, and more particularly in the manufacture of light-emitting diode (LED) reflectors.

### PRIOR ART AND TECHNICAL PROBLEM

The construction of certain types of screen for electronic equipment (televisions, computers, telephones, touch tablets, etc.) has been resorting, for a few years already, to the integration of light-emitting diodes (LED) as main sources of illumination on account of their high luminous efficacy. However, in order for this luminous efficacy to be long-lasting, it is necessary for the elements that reflect the light generated by the LEDs not to be impaired, i.e. not to lose their white color, under the high temperatures that are generated during the manufacturing process or during the functioning of these LEDs. As a result, it is necessary for these elements (reflectors) to be designed with materials that have high heat resistance.

Materials having such heat resistance may especially be obtained from compositions comprising at least one semiaromatic polyamide as described in document JP 2006-257314.

More particularly, the composition described in document JP 2006-257314 comprises, per 100 parts by weight of a semiaromatic polyamide:
from 5 to 100 parts by weight of titanium dioxide TiO₂,
from 20 to 100 parts by weight of reinforcers chosen from fillers in fiber form and fillers in needle form, and
from 0.5 to 30 parts by weight of magnesium hydroxide, the semiaromatic polyamide comprising dicarboxylic acid units containing from 50 mol % to 100 mol % of terephthalic acid units and diamine units comprising from 60% to 100% of 1,9-nonanediamine and/or of 2-methyl-1,8-octanediamine.

Such compositions prove to be satisfactory in terms of heat resistance, meaning that the properties of the material obtained therefrom are sparingly impaired under the effect of the temperature generated, either during the manufacture of the LEDs, or by the LEDs when functioning.

However, the Applicant has found that these compositions do not entirely satisfy another important criterion, which is the resistance to the light generated by the LEDs, in order to further optimize the luminous efficacy of LED screens by retarding the coloration, especially the yellowing, which harms the reflectance of the material obtained from these compositions.

There is thus a real need to find compositions that make it possible to obtain a material which can constitute all or part of the LED reflectors, this material simultaneously having very good heat resistance (resistance to temperature, whether it arises during the process for the manufacture of the LEDs or whether it is generated by the LEDs when functioning) and very good LED resistance (resistance to the light generated by the LEDs).

### BRIEF DESCRIPTION OF THE INVENTION

The Applicant has found that these heat resistance and LED resistance properties are jointly achieved with a material obtained from a composition comprising, the weight percentages being given relative to the total weight of the composition:
from 30% to 97% by weight of at least one semiaromatic polyamide comprising:
   from 55 mol % to 100 mol % of a repeating unit (A) obtained from the polycondensation of at least one aliphatic diamine comprising from 4 to 18 carbon atoms and of at least one aromatic dicarboxylic acid including terephthalic acid, and
   from 0 to 45 mol % of a repeating unit (B) obtained from at least one element chosen from the group consisting of a lactam comprising from 9 to 12 carbon atoms, a nonaromatic aminocarboxylic acid comprising from 9 to 12 carbon atoms and the product of polycondensation of at least one diamine comprising from 4 to 36 carbon atoms and of at least one nonaromatic dicarboxylic acid comprising from 4 to 36 carbon atoms,
from 2% to 50% by weight of white pigments,
from 0 to 50% by weight of reinforcers, and
from 0.1% to 10% by weight of at least one metal hydroxide and/or of at

least one metal oxide, with the exception of a transition metal oxide, said composition also comprising an organic phosphite, in a content which may be up to 3% by weight.

A subject of the present invention is also the use of the composition according to the invention for obtaining a material intended for constituting all or part of LED reflectors.

Finally, a subject of the present invention is a light-emitting diode (LED) reflector totally or partly consisting of a material obtained from a composition according to the invention.

### DETAILED DESCRIPTION OF THE INVENTION

Other characteristics, aspects, objects and advantages of the present invention will emerge even more clearly on reading the description which follows.

The nomenclature used to define the polyamides is described in standard ISO 1874-1:1992 “Plastics—Polyamide (PA) materials for molding and extrusion—Part 1: Designation”, especially on page 3 (tables 1 and 2) and is well known to those skilled in the art.

Moreover, it is pointed out that the expressions “. . . from . . . to . . . ” and “. . . between . . . and . . . ” used in this description should be understood as including the cited limits.

The invention relates to a composition comprising from 30% to 97% by weight of at least one particular semiaromatic polyamide which will be detailed hereinbelow, from 2% to 50% by weight of white pigments, from 0 to 50% by weight of reinforcers and from 0.1% to 10% by weight of at least one metal hydroxide and/or of at least one metal oxide (with the exception of a transition metal oxide), said composition also comprising an organic phosphite, in a content which may be up to 3% by weight.

It is pointed out that the weight percentages that have just been mentioned are given relative to the total weight of the composition according to the invention.

The Applicant has been able to observe, surprisingly and unexpectedly, that the composition according to the invention made it possible to maintain the heat resistance properties of the reflectors at the level of those of reflectors obtained from known compositions, especially from JP 2006-257 314, but, on the other hand, made it possible to improve their LED resistance properties, in a significant manner.

The composition according to the invention comprises from 30% to 97% by weight, relative to the total weight of the composition, of at least one semiaromatic polyamide.

Advantageously, the weight proportion of the semiaromatic polyamide(s) in the composition is between 35% and 84% by weight and advantageously between 40% and 68% by weight, relative to the total weight of the composition.

According to a first embodiment of the invention, the semiaromatic polyamide of the composition consists of:
from 55 mol % to 100 mol % of a repeating unit (A) obtained from the polycondensation of an aliphatic diamine comprising from 4 to 18 carbon atoms and of terephthalic acid, and
from 0 to 45 mol % of a repeating unit (B) obtained from a lactam comprising from 9 to 12 carbon atoms, an aminocarboxylic acid comprising from 9 to 12 carbon atoms or from the product of polycondensation of a diamine comprising from 4 to 36 carbon atoms and of a nonaromatic dicarboxylic acid comprising from 4 to 36 carbon atoms.

In a particular variant of the invention, the semiaromatic polyamide may comprise only repeating units (A) and, consequently, be a homopolyamide.

According to a second embodiment of the invention, the semiaromatic polyamide of the composition comprises:
from 55 mol % to 100 mol % of a repeating unit (A) obtained from the polycondensation of at least one aliphatic diamine comprising from 4 to 18 carbon atoms and of at least one aromatic dicarboxylic acid including terephthalic acid, and
from 0 to 45 mol % of a repeating unit (B) obtained from at least one element chosen from the group consisting of a lactam comprising from 9 to 12 carbon atoms, an aminocarboxylic acid comprising from 9 to 12 carbon atoms and the product of polycondensation of at least one diamine comprising from 4 to 36 carbon atoms and of at least one nonaromatic dicarboxylic acid comprising from 4 to 36 carbon atoms.

In another particular variant of the invention, the semiaromatic polyamide may comprise only repeating units (A) and, consequently, correspond to a copolyamide which is formed only by semiaromatic units.

In a variant of the first or second embodiment of the invention, the semiaromatic polyamide of the composition according to the invention may comprise from 60 mol % to 90 mol % of the repeating unit (A) and from 10 mol % to 40 mol % of the repeating unit (B).

In another variant, the semiaromatic polyamide of the composition according to the invention may consist of 70 mol % to 80 mol % of the repeating unit (A) and 20 mol % to 30 mol % of the repeating unit (B).

Advantageously, the semiaromatic polyamide(s) are characterized by a melting point of at least 260° C., preferentially of at least 270° C. and even more preferentially of at least 280° C., the melting point being measured by DSC, according to standard ISO 11357.

Unless otherwise mentioned, the description which follows is valid for the semiaromatic polyamide, whether the latter corresponds to the first embodiment or to the second embodiment mentioned above.

The repeating unit (A) of the semiaromatic polyamide of the composition according to the invention is obtained from the polycondensation of one or of at least one diamine and of one or of at least one aromatic dicarboxylic acid, said at least one aromatic dicarboxylic acid being terephthalic acid. In other words, if only one aromatic dicarboxylic acid is used during the polycondensation, it is terephthalic acid. In the case where several aromatic dicarboxylic acids are used during the polycondensation, terephthalic acid is necessarily present among these acids, preferably in a predominant mole proportion relative to all of the other aromatic dicarboxylic acids.

The diamine used for obtaining this repeating unit (A) is an aliphatic diamine which has a linear main chain comprising at least 3 carbon atoms.

This linear main chain may, where appropriate, comprise one or more methyl and/or ethyl substituents; in the latter configuration, it is referred to as a “branched aliphatic diamine”. In the case where the main chain does not comprise any substituents, the aliphatic diamine is referred to as a “linear aliphatic diamine”.

Whether it comprises methyl and/or ethyl substituents on the main chain or not, the aliphatic diamine used for obtaining this repeating unit (A) comprises from 4 to 18 carbon atoms, advantageously from 6 to 14 carbon atoms and preferentially 10 carbon atoms.

When this diamine is a linear aliphatic diamine, it then corresponds to the formula H₂N-(CH₂)ₓ-NH₂ and may be chosen from butanediamine, pentanediamine, hexanediamine, heptanediamine, octanediamine, nonanediamine, decanediamine, undecanediamine, dodecanediamine, tridecanediamine, tetradecanediamine, hexadecanediamine, octadecanediamine and octadecenediamine. The linear aliphatic diamines that have just been mentioned all have the advantage of being biosourced within the meaning of standard ASTM D6866.

When this diamine is a branched aliphatic diamine, it may especially be 2-methylpentanediamine or 2-methyl-1,8-octanediamine.

The diamine is advantageously a linear aliphatic diamine within the meaning of the invention. Preferably, this diamine is decanediamine.

To obtain this repeating unit (A), it may be envisioned to use only one aliphatic diamine comprising from 4 to 18, advantageously from 6 to 14 and preferentially 10 carbon atoms.

A mixture of two, or more, aliphatic diamines may also be envisioned, all these aliphatic diamines necessarily comprising from 4 to 18, advantageously from 6 to 14 and preferentially 10 carbon atoms, and obviously being different in pairs. This case then falls within the second embodiment of the invention.

The dicarboxylic acid(s) used for obtaining this repeating unit (A) are aromatic dicarboxylic acids, among which is necessarily terephthalic acid (noted T).

Thus, to obtain this repeating unit (A), it may be envisioned to use only terephthalic acid.

A mixture of two, or more, aromatic dicarboxylic acids including at least terephthalic acid may also be envisioned, these other acids obviously being different in pairs. This case then falls within the second embodiment of the invention.

This or these other aromatic dicarboxylic acid(s) may be chosen from isophthalic acid (noted I) and naphthalenic diacids. Among the naphthalenic acids, mention may be made specially of naphthalene-2,6-dicarboxylic acid.

More preferentially, the repeating unit (A) denotes the following units: 6.T, 8.T, 9.T, 10.T, 11.T, 12.T, 10.T/6.T, 10.T/12.T, 6.T/6.I and 10.T/10.1.

The repeating unit (B) of the semiaromatic polyamide of the composition according to the invention is obtained from at least one of the following compounds:
a lactam,
an aminocarboxylic acid, and/or
the product of polycondensation of a diamine and of a nonaromatic dicarboxylic acid.

To obtain this repeating unit (B), it may be envisioned to use only one of the compounds that have just been mentioned.

To obtain this repeating unit (B), a mixture of two or more of the compounds that have just been described may also be envisioned. This case then falls within the second embodiment of the invention.

The lactam used for obtaining this repeating unit (B) is a lactam which comprises from 9 to 12 carbon atoms and advantageously from 10 to 12 carbon atoms. It may thus be chosen from decanolactam, undecanolactam and lauryllactam, and is preferentially lauryllactam.

To obtain this repeating unit (B), it may be envisioned to use only one lactam comprising from 9 to 12 carbon atoms.

A mixture of two, or more, lactams may also be envisioned, all these lactams necessarily comprising from 9 to 12 carbon atoms and obviously being distinct in pairs. This case then falls within the second embodiment of the invention.

The aminocarboxylic acid used for obtaining this repeating unit (B) is an aminocarboxylic acid which comprises from 9 to 12 carbon atoms and advantageously from 10 to 12 carbon atoms.

In an advantageous variant of the invention, this aminocarboxylic acid is linear and nonbranched. It may thus be chosen from 9-aminononanoic acid, 10-aminodecanoic acid, 10-aminoundecanoic acid, 11-aminoundecanoic acid and 12-aminododecanoic acid.

Preferentially, the aminocarboxylic acid is 11-aminoundecanoic acid, which also has the advantage of being biosourced within the meaning of standard ASTM D6866.

To obtain this repeating unit (B), it may be envisioned to use only one aminocarboxylic acid comprising from 9 to 12 carbon atoms.

A mixture of two, or more, aminocarboxylic acids may also be envisioned, all these aminocarboxylic acids necessarily comprising from 9 to 12 carbon atoms and obviously being different in pairs. This case then falls within the second embodiment of the invention.

The repeating unit (B) may also be obtained from the polycondensation of one or of at least one diamine and of one or of at least one nonaromatic dicarboxylic acid, these diamine and nonaromatic dicarboxylic acid each comprising from 4 to 36, advantageously from 6 to 18 and preferentially from 10 to 14 carbon atoms.

The diamine used for obtaining this repeating unit (B) may be chosen from linear or branched aliphatic diamines, cycloaliphatic diamines and alkylaromatic diamines.

When this diamine is aliphatic and linear, it corresponds to the formula H₂N-(CH₂)ₓ-NH₂ and may be chosen from butanediamine, pentanediamine, hexanediamine, heptanediamine, octanediamine, nonanediamine, decanediamine, undecanediamine, dodecanediamine, tridecanediamine, tetradecanediamine, hexadecanediamine, octadecanediamine, octadecenediamine, eicosanediamine, docosanediamine and the diamines obtained from fatty acids.

When this diamine is aliphatic and branched, it may especially be 2-methylpentanediamine or 2-methyl-1,8-octanediamine. When this diamine is cycloaliphatic, it may be chosen from bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis(3-methyl-4-aminocyclohexyl)methane (BMACM or MACM), p-bis(aminocyclohexyl)methane (PACM) and isopropylidenedi(cyclohexylamine) (PACP). It may also comprise the following carbon backbones: norbornylmethane, cyclohexylmethane, dicyclohexylpropane, bis(methylcyclohexyl), bis(methylcyclohexyl)propane. A nonexhaustive list of these cycloaliphatic diamines is given in the publication “Cycloaliphatic Amines” (Encyclopaedia of Chemical Technology, Kirk-Othmer, 4th Edition (1992), pp. 386-405).

When this diamine is alkylaromatic, it may be chosen from 1,3-xylylenediamine and 1,4-xylylenediamine.

The dicarboxylic acid used for obtaining this repeating unit (B) is itself nonaromatic and may be chosen from linear or branched aliphatic dicarboxylic acids and cycloaliphatic dicarboxylic acids.

When this dicarboxylic acid is aliphatic and linear, it may be chosen from succinic acid, pentanedioic acid, adipic acid, heptanedioic acid, octanedioic acid, azelaic acid, sebacic acid, undecanedioic acid, dodecanedioic acid, brassylic acid, tetradecanedioic acid, hexadecanedioic acid, octadecanedioic acid, octadecenedioic acid, eicosanedioic acid, docosanedioic acid and fatty acid dimers containing 36 carbons.

The fatty acid dimers mentioned above are dimerized fatty acids obtained by oligomerization or polymerization of long-chain hydrocarbon-based unsaturated monobasic fatty acids (such as linoleic acid and oleic acid), as described especially in document EP 0 471 566.

When this dicarboxylic acid is cycloaliphatic, it may comprise the following carbon backbones: norbornylmethane, cyclohexane, cyclohexylmethane, dicyclohexylmethane, dicyclohexylpropane, bis(methylcyclohexyl), bis(methylcyclohexyl)propane.

To obtain this repeating unit (B), it may be envisioned to use only one diamine and only one nonaromatic dicarboxylic acid.

To obtain this repeating unit (B), a mixture of two, or more, diamines with one, two or more nonaromatic dicarboxylic acids may also be envisioned, but also a mixture of two, or more, nonaromatic dicarboxylic acids with one, two or more diamines. In all cases, all these diamines and nonaromatic dicarboxylic acids each comprise from 4 to 36 carbon atoms and are obviously different in pairs. This case then falls within the second embodiment of the invention.

Preferably, the repeating unit (B) denotes nonbranched linear aliphatic units, whether these units originate from a lactam, an aminocarboxylic acid or a product of the reaction of a diamine and of a nonaromatic dicarboxylic acid.

More preferentially, the repeating unit (B) denotes the following units: 6, 11, 12, 6.10, 6.12, 6.14, 6.18, 10.10, 10.12, 10.14, 10.18, 12.10, 12.12, 12.14 and 12.18.

Among the combinations that may be envisioned for the first embodiment of the invention, the following semiaromatic polyamides are of particularly pronounced interest: they are copolyamides corresponding to one of the formulae chosen from 10/6.T, 11/6.T, 12/6.T, 10/9.T, 10/10.T, 10/11.T, 10/12.T, 11/9.T, 11/10.T, 11/11.T, 11/12.T, 12/9.T, 12/10.T, 12/11.T, 12/12.T, 6.10/6.T, 6.12/6.T, 10.10/6.T, 10.12/6.T, 6.10/10.T, 6.12/10.T, 10.10/10.T, 10.12/10.T, 6.10/12.T, 6.12/12.T, 10.10/12.T and 10.12/12.T.

Among the combinations that may be envisioned for the second embodiment of the invention, the following semiaromatic polyamides are of particularly pronounced interest: they are copolyamides corresponding to one of the formulae chosen from 11/12/6.T, 11/12/10.T, 11/12/11.T, 11/12/12.T, 10/6.T/10.T, 10/6.T/11.T, 10/6.T/12.T, 10/10.T/11.T, 10/10.T/12.T, 10/11.T/12.T, 11/6.T/10.T, 11/6.T/11.T, 11/6.T/12.T, 11/10.T/11.T, 11/10.T/12.T, 11/11.T/12.T, 12/6.T/10.T, 12/6.T/11.T, 12/6.T/12.T, 12/10.T/11.T, 12/10.T/12.T, 12/11.T/12.T, 10/6.T/6.1, 10/10.T/10.1, 11/6.T/6.1, 11/9.T/9.1, 11/10.T/10.1, 11/11.T/11.1, 11/12.T/12.1, 12/6.T/6.1, 12/9.T/9.I, 12/10.T/10.1, 12/11.T/11.I and 12/12.T/12.I.

The composition according to the invention may comprise only one semiaromatic polyamide or a mixture of two or more semiaromatic polyamides as described above, this or these semiaromatic polyamides being in accordance with the first and/or second embodiment.

In addition to the semiaromatic polyamide(s), the composition according to the invention comprises from 2% to 50% by weight, relative to the total weight of the composition, of white pigments.

Specifically, the white pigments improve the reflectance of the materials obtained from the compositions according to the invention, which is of major interest for a use in the manufacture of LED reflectors.

Advantageously, the weight proportion of the white pigments in the composition is between 10% and 40% by weight and advantageously between 20% and 35% by weight relative to the total weight of the composition.

The white pigments commonly used are zinc oxide ZnO and titanium dioxide TiO₂. Advantageously, titanium dioxide TiO₂ is used.

The composition according to the invention may also comprise reinforcers, in a content that may be up to 50% by weight, relative to the total weight of the composition.

Advantageously, the weight proportion of reinforcers is between 5% and 30% by weight and advantageously between 10% and 15% by weight relative to the total weight of the composition.

According to an advantageous variant, the reinforcers are in the form of white or transparent fibers. These fibers may be chosen especially from glass fibers, mica fibers, aramid fibers (entirely aromatic polyamides). Advantageously, the fibers are glass fibers.

The glass fibers commonly used have a size advantageously between 0.20 and 25 mm.

To improve the adhesion of the fibers to the semiaromatic polyamide(s), a coupling agent such as silanes or titanates, which are known to those skilled in the art, may be added to the composition.

The composition according to the invention also comprises from 0.1% to 10% by weight, relative to the total weight of the composition, of at least one metal hydroxide and/or of at least one metal oxide, with the exception of a transition metal oxide.

Advantageously, the weight proportion of metal hydroxide and/or oxide mentioned above is between 0.5% and 5% by weight and advantageously between 1% and 3.5% by weight relative to the total weight of the composition.

This metal hydroxide may be in the form of an oxide-hydroxide of only one or of several metals.

According to an advantageous version, the metal hydroxide is chosen from magnesium hydroxide Mg(OH)₂, calcium hydroxide Ca(OH)₂ and aluminum hydroxide Al(OH)₃, and is advantageously magnesium hydroxide Mg(OH)₂.

The metal oxide that is used may be an oxide of only one or of several metals, the metal(s) not being a transition metal. It may especially be an oxide of an alkali metal and/or of an alkaline-earth metal. Preferably, an oxide of an alkaline-earth metal is used.

According to an advantageous version, the metal oxide is chosen from magnesium oxide MgO and calcium oxide CaO.

It is obviously possible to use mixtures of only one or of several metal hydroxides with only one or several metal oxides such as those mentioned above.

The composition according to the invention also comprises an organic phosphite, in a content which may be up to 3% by weight relative to the total weight of the composition.

Advantageously, the weight proportion of organic phosphite is between 0.1% and 2% by weight and advantageously between 0.5% and 1% by weight relative to the total weight of the composition.

The inventors have observed that the addition, in relatively low amounts, of this organic phosphite to the composition of the invention makes it possible to improve the luminous efficacy by improving the LED resistance combined with maintaining the heat resistance of the material obtained from said composition.

A composition in accordance with the invention may also comprise at least one usual additive or polyamides.

Among these additives, mention may be made especially of fillers, flame retardants optionally supplemented with flame-retardant activators, stabilizers (such as UV stabilizers), plasticizers, surfactants, optical brighteners, antioxidants, mold-release agents, and mixtures thereof.

As a function of their nature, the additives may represent up to 90% by weight, advantageously from 1% to 60% by weight, preferably from 20% to 50% by weight and more preferentially about 40% by weight, relative to the total weight of the composition.

Among the fillers that may be introduced into the composition of the invention, mention may be made of mineral fillers such as kaolin, wollastonite, talc, silica, zeolites, it being pointed out that talc and silica are also known as nucleating agents.

Among the known flame retardants, mention may also be made of melamine cyanurate and also phosphorus, derivatives thereof such as red phosphorus (U.S. Pat. No. 3,778,407), phosphates and phosphinates. Mention may also be made of the flame retardants and flame-retardant activators described in document FR 2 900 409, which are particularly suited to compositions based on semiaromatic polyamides.

It is pointed out that by adding phosphorus additives, some of which may moreover be flame retardants, the reflectance of the materials obtained from the composition according to the invention is further improved.

Among the UV stabilizers generally used in compositions for materials intended for LED reflectors, mention may be made of hindered amine light stabilizers (HALS).

The stabilizers, and especially UV stabilizers, may represent up to 6% by weight, advantageously from 0.05% to 3% by weight and preferably from 0.1% to 1% by weight relative to the total weight of the composition.

Among the antioxidants, mention may be made of phenolic antioxidants.

Among the mold-release agents, mention may be made of natural waxes, calcium stearate and calcium montanate.

A composition in accordance with the invention may also additionally comprise at least a second polymer.

Advantageously, this second polymer may be chosen from a semicrystalline polyamide, an amorphous polyamide, a semicrystalline copolyamide, an amorphous copolyamide, a polyetheramide, a polyesteramide, polyphenylene sulfide (PPS), an aromatic polyester, an arylamide, and mixtures thereof.

In particular, this second polymer may be one or more functional polyolefins (such as an impact modifier) or nonfunctional polyolefins, which may or may not be crosslinked.

The compositions according to the invention may be prepared via any method that makes it possible to obtain a homogeneous mixture, such as melt extrusion, compacting or roll blending.

More particularly, the composition according to the invention is prepared by melt blending of all the products, for example in a “direct” process.

Advantageously, the composition may be obtained in the form of granules by compounding on a tool known to those skilled in the art, such as a twin-screw extruder, a co-kneader or an internal mixer.

The composition according to the invention obtained via the preparation process described above may then be transformed for a use or a subsequent transformation known to those skilled in the art with the aid of tools such as an injection press or an extruder.

The invention thus also relates to an article obtained by injection, extrusion, extrusion blow-molding, coextrusion, multiinjection using at least one composition as defined above.

The process for preparing the composition according to the invention may also use a twin-screw extruder feeding, without intermediate granulation, an injection press or an extruder according to an implementation device known to those skilled in the art.

The present invention also relates to the use of a composition as described above for making a powder, granules, a monolayer structure or at least one layer of a multilayer structure.

The composition as described above may be used for obtaining parts, in particular injected parts.

Among these parts, mention will be made most particularly of light-emitting diode (LED) reflectors.

Such parts may be intended for the industrial field in general, and for the electrical and electronics industry in particular.

Such parts may be most particularly treated via the technology known as surface-mount technology (SMT) using the composition according to the invention. This composition may in particular be used as a brazing composition.

Finally, the present invention relates to a light-emitting diode (LED) reflector which may consist totally or partly of a material obtained from a composition as described above.

### Examples

Products

The compositions that were tested were prepared from the following products:
Polyamide 11/6.T: this copolyamide, which comprises 33 mol % of repeating unit (B) derived from 11-aminocarboxylic acid and 67 mol % of repeating unit (A) derived from the polycondensation of hexanediamine and terephthalic acid, has a glass transition temperature Tg of 95° C., a melting point Tm of 315° C., an inherent viscosity of 0.9 and a heat of fusion of 50 J/g.
Polyamide 11/10.T: this copolyamide, which comprises 10 mol % of repeating unit (B) derived from 11-aminocarboxylic acid and 90 mol % of repeating unit (A) derived from the polycondensation of decanediamine and of terephthalic acid, has a glass transition temperature Tg of 95° C., a melting point Tm of 305° C., an inherent viscosity of 0.9 and a heat of fusion of 60 J/g.
TiO₂: this titanium oxide corresponds to the grade Kronos 2222 sold by the company Kronos.
Glass fibers (GF): these glass fibers correspond to the grade CS 03 JA FT 692 sold by the company Asahi.
Mg(OH)₂: this magnesium hydroxide corresponds to the grade Magnifin H10 sold by the company Albemarle.
Phosphite: this organic phosphite corresponds to the grade Irgafos PEP-Q sold by the company Ciba.
Talc: this nucleating agent corresponds to the grade Steamic 00S D G sold by the company Luzenac NV.
Antioxidant: this is the grade ADK STAB A080 which is a phenolic antioxidant sold by the company Adeka Palmarole.
Mold-release agent: this agent is calcium stearate.
HALS: this UV stabilizer corresponds to the grade Chimasorb 944 sold by the company Ciba.

Compositions 1 to 6/Specimens A to F

The compositions were prepared by compounding (blending) in the melt on a Werner-Pfleiderer ZSK40 twin-screw extruder, with a screw speed of 250 revolutions/minute, a flow rate of 60 kg/h and a temperature of 320° C. The formulation of each of the six compositions 1 to 6 prepared is given in Table 1 below.

TABLE 1

| Composition | 1 | 2 | 3 | 4 | 5 | 6 |
|---|---|---|---|---|---|---|
| 11/6.T | 51.6 | 49.2 | 48.7 | 0 | 0 | 0 |
| 11/10.T | 0 | 0 | 0 | 51.6 | 49.2 | 48.7 |
| TiO₂ | 35 | 35 | 35 | 35 | 35 | 35 |
| GF | 10 | 10 | 10 | 10 | 10 | 10 |
| Mg(OH)₂ | 0.6 | 3 | 3 | 0.6 | 3 | 3 |
| Phosphite | 0 | 0 | 0.5 | 0 | 0 | 0.5 |
| Talc | 2 | 2 | 2 | 2 | 2 | 2 |
| Antioxidant | 0.4 | 0.4 | 0.4 | 0.4 | 0.4 | 0.4 |
| Mold-release | 0.2 | 0.2 | 0.2 | 0.2 | 0.2 | 0.2 |
| agent | | | | | | |
| HALS | 0.2 | 0.2 | 0.2 | 0.2 | 0.2 | 0.2 |

Compositions 3 and 6 are two compositions in accordance with the invention, whereas compositions 1, 2, 4 and 5 are comparative compositions.

Specimens A to F were prepared, respectively, from each of the compositions 1 to 6 in accordance with standard ISO R527.

Test Results

To evaluate the resistance to high temperatures (noted “heat resistance” in Table 2 below) of the materials obtained from the six compositions A to F, aging tests, in hot air at 170° C. and for 168 hours, were performed on the specimens mentioned above.

To evaluate the resistance to the light generated by LEDs (“LED resistance” hereinbelow in Table 2) of these same materials, the specimens mentioned above were subjected to a blue LED light (wavelength of 440 nm), in an environment at 80° C. and for 400 hours.

The heat resistance and the LED resistance of the specimens were respectively evaluated. The values obtained are reported in Table 2 below, it being pointed out that each of the following abbreviations:
“−” means “poor”
“+−” means “moderate”
“₊” means “good”
“++” means “very good”
“+++” means “excellent”

TABLE 2

| Composition | 1 | 2 | 3 | 4 | 5 | 6 |
|---|---|---|---|---|---|---|
| Specimen | A | B | C | D | E | F |
| Heat | + | + | + | ++ | ++ | ++ |
| resistance | | | | | | |
| LED | − | + | ++ | +− | ++ | +++ |
| resistance | | | | | | |

It may be observed that, although the heat resistance is not modified by adding 0.5% by weight of phosphite to the compositions according to the invention (same heat resistance values between the specimens C according to the invention and the comparative specimens B, on the one hand, and the specimens F according to the invention and the comparative specimens E, on the other hand), the LED resistance is significantly improved:
by passing from “good” for the comparative specimens B to “very good” in the case of the specimens C,
by passing from “very good” for the comparative specimens E to “excellent” in the case of the specimens F.

By comparing the comparative specimens A and B with each other, on the one hand, and also the specimens D and E with each other, on the other hand, it also emerges from this Table 2 that the LED resistance may already be improved, in the absence of organic phosphite, by varying the weight proportion of magnesium hydroxide.

However, the combination of magnesium hydroxide with the organic phosphite in the compositions according to the invention makes it possible to achieve the most efficient LED resistance values, the other compounds and the respective weight proportion thereof being comparable.

1. A composition comprising, the weight percentages being given relative to the total weight of the composition:
from 30% to 97% by weight of at least one semiaromatic polyamide comprising:
from 55 mol % to 100 mol % of a repeating unit (A) obtained from the polycondensation of at least one aliphatic diamine comprising from 4 to 18 carbon atoms and of at least one aromatic dicarboxylic acid including terephthalic acid, and
from 0 to 45 mol % of a repeating unit (B) obtained from at least one element chosen from the group consisting of a lactam comprising from 9 to 12 carbon atoms, a nonaromatic aminocarboxylic acid comprising from 9 to 12 carbon atoms and the product of polycondensation of at least one diamine comprising from 4 to 36 carbon atoms and of at least one nonaromatic dicarboxylic acid comprising from 4 to 36 carbon atoms,
from 2% to 50% by weight of white pigments,
from 0 to 50% by weight of reinforcers, and
from 0.1% to 10% by weight of at least one metal hydroxide and/or of at least one metal oxide, with the exception of a transition metal oxide,
said composition also comprising an organic phosphite, in a content which may be up to 3% by weight.

2. The composition as claimed in claim 1, characterized in that the semiaromatic polyamide(s) have a melting point of at least 260° C., preferentially of at least 270° C. and even more preferentially of at least 280° C., the melting point being measured by DSC, according to standard ISO 11357.

3. The composition as claimed in claim 1, characterized in that the aliphatic diamine of the repeating unit (A) is linear and comprises from 6 to 14 carbon atoms and advantageously 10 carbon atoms.

4. The composition as claimed in claim 1, characterized in that the lactam comprises from 10 to 12 carbon atoms.

5. The composition as claimed in claim 1, characterized in that the aminocarboxylic acid comprises from 10 to 12 carbon atoms, advantageously 11 carbon atoms.

6. The composition as claimed in claim 1, characterized in that the content of white pigments is between 10% and 40% by weight and advantageously between 20% and 35% by weight relative to the total weight of the composition.

7. The composition as claimed in claim 1, characterized in that the white pigments are titanium dioxide TiO₂.

8. The composition as claimed in claim 1, characterized in that the content of reinforcers is between 5% and 30% by weight and advantageously between 10% and 15% by weight relative to the total weight of the composition.

9. The composition as claimed in claim 1, characterized in that the reinforcers are in the form of fibers, such as glass fibers.

10. The composition as claimed in claim 1, characterized in that the content of metal hydroxide and/or of metal oxide is between 0.5% and 5% by weight and advantageously between 1% and 3.5% by weight relative to the total weight of the composition.

11. The composition as claimed in claim 1, characterized in that the metal hydroxide is chosen from magnesium hydroxide Mg(OH)₂, calcium hydroxide Ca(OH)₂ and aluminum hydroxide Al(OH)₃ and is advantageously magnesium hydroxide Mg(OH)₂.

12. The composition as claimed in claim 1, characterized in that the metal oxide is chosen from magnesium oxide MgO and calcium oxide CaO.

13. The composition as claimed in claim 1, characterized in that the content of organic phosphite is between 0.1% and 2% by weight and advantageously between 0.5% and 1% by weight relative to the total weight of the composition.

14. The composition as claimed in claim 1, characterized in that it also comprises at least one additive chosen from fillers, flame retardants optionally supplemented with flame-retardant activators, stabilizers (such as UV stabilizers), plasticizers, surfactants, optical brighteners, antioxidants and mold-release agents, and mixtures thereof.

15. A process for preparing a composition as claimed in claim 1, characterized in that it comprises a step of melt-blending of all the products.

16. In an electronic part, for the electrical or electronics industry, comprising a semiaromatic polyamide, the improvement wherein the semiaromatic polyamide is a composition according to claim 1.

17. The electronic part according to claim 16, that is a light-emitting diode (LED) connector, switch or reflector.

18. A light-emitting diode (LED) reflector consisting totally or partly of a material obtained from a composition as defined in claim 1.
